(19) United States
(12) Patent Application Publication
(10) Pub. No.: US 2011/0179072 A1
(43) Pub. Date: Jul. 21, 2011

(54) BUSINESS DOCUMENT PROCESSOR

(75) Inventors: Toshiko Matsumoto, Tokyo (JP); Ryo Nakashige, Tokyo (JP); Yasuyuki Nozaki, Tokyo (JP); Mitsuharu Oba, Tokyo (JP)

(73) Assignee: HITACHI SOLUTIONS, LTD., Tokyo (JP)

(21) Appl. No.: 13/120,480

(22) PCT Filed: Nov. 27, 2009
(86) PCT No.: PCT/JP2009/006427

§ 371 Date: Mar. 23, 2011

(30) Foreign Application Priority Data
Dec. 2, 2008 (JP) 2008-307943

(51) Int. Cl. G06F 17/30

(52) U.S. Cl. 707/769; 707/E17.014

(57) ABSTRACT

To create and manage vouchers by fully checking the contents of the vouchers so that the vouchers will not contain any flaws in description. Information described in a voucher is analyzed through the analysis of the logical structure of the voucher. It is checked, based on RCM (risk control matrix) prepared for internal control purposes, if an item described in the voucher satisfies a predetermined relationship and also if items described in vouchers, which are generated through a series of operations, satisfy a predetermined relationship. Then, a warning is displayed and entry of modification is accepted.

### TECHNICAL FIELD

The present invention relates to a business document processor that performs check processing for information described in business documents and register such documents in a database. For example, the invention relates to registering and checking business documents through the analysis of the logical structures of such documents.

### BACKGROUND ART

With the enforcement of the J-SOX (the Japanese version of the, or Financial Products Trading Law), handling of vouchers by enterprises in their operating activities has drawn increasing attention. In the meanwhile, for business vouchers used by enterprises, in particular, non-standardized paper documents are often used even now because of the following two reasons. This has been problematic in management.

The first reason is that when an enterprise performs a business transaction with a customer (e.g., a client, business partner, or vendor) via a business voucher, the enterprise needs to create a voucher in compliance with the format defined by the customer in some cases. Therefore, fixed documents cannot always be used even in routine tasks, and it is thus impossible to fully accomplish digitization or automation of documents.

The second reason is that there are cases in which voucher documents such as forms submitted to the management division of an enterprise should be newly created, abolished, merged, or changed in formats according to changes in the legal systems, business environment, or company's management policies. Accordingly, there are frequent needs for the document formats to be changed, thus hindering digitization and automation of documents.

Meanwhile, in internal control, it is vital that the accuracy of information described in vouchers be ensured and the vouchers be stored adequately. In order to prevent any flaws in the descriptions of vouchers, it is necessary to create and manage vouchers by fully checking items (RCM: risk control matrix) such as those exemplarily listed below.

Exemplary Check Item 1: Is the transaction amount within the credit limit set for a given customer?

Exemplary Check Item 2: Is the credit limit re-set in accordance with the trading interval?

Exemplary Check Item 3: Has any approval been obtained from an authorized decision-maker at an equal level to or higher level than the position set out for each transaction amount or transaction type?

Exemplary Check Item 4: Is the voucher creation date preceded by the voucher storage date?

Exemplary Check Item 5: Contrary to Exemplary Check Item 4, isn't there too long interval between the voucher creation date and the voucher storage date?

Exemplary Check Item 6: Do the following items: company name, monetary amount, delivery due date, delivery conditions, acceptance due date, payment due date, payment conditions, and the like match between the following documents: a quotation, purchase order, order confirmation, shipping slip, acceptance certificate, invoice, receipt, and the like?

Exemplary Check Item 7: Does the division that creates purchase orders or shipping slips differ from the division that deals with payment-receiving procedures or disbursement procedures?

Exemplary Check Item 8: Does the voucher creation date comply with the order defined in the workflow?

However, in business operations based on paper documents, users have no choice but to rely on their visual checks on the documents. Thus, there are risks such that in audit, auditors may point out flaws in vouchers or may assert that the enterprise has problems in its internal control, which could have resulted from management deficiencies caused by human errors or a lack of users' awareness.

Further, cases may arise in which vouchers should be handled irregularly depending on a variety of circumstances. For example, an order for which a single quotation has been issued may be split into more than one order, or an official voucher may be received a few days after the confirmation via FAX. In such cases, one should be prepared to explain the reasons (why such irregular handling has occurred). If one fails to do so, he/she may only have a vague memory in audit, which could result in a factor to increase the number of checking steps.

As a system that manages documents in enterprises, those described in Non Patent Literature 1 to 4 have been devised.

In addition, in order to check the content of a voucher, it is necessary to analyze the logical structure thereof from a scanned image of the paper document, and automatically extract a value corresponding to a given item. Such techniques are described in Patent Literature 1 to 3.

### CITATION LIST

### Patent Literature

PTL 1: JP Patent Application No. 7-341983 (1995)
PTL 2: JP Patent Application No. 10-64431 (1998)
PTL 3: JP Patent Application No. 2000-163784

### Non Patent Literature

NPL 1: Documentum (EMC Japan K.K.) http://japan.emc.com/products/family/documentum-family.htm
NPL 2: DocumentBroker (Hitachi, Ltd.) http://www.hitachi.co.jp/Prod/comp/soft1/docbro/NPL
NPL 3: Ridoc (Ricoh Company, Ltd.) http://www.ricoh.co.jp/ridoc_ds/rds/NPL
NPL 4: FileNet (IBM Japan, Ltd.) http://www.ibm.com/developerworks/jp/ysl/library/db2/y-db2-filenetp8-1/

### SUMMARY OF INVENTION

### Technical Problem

However, each of the systems disclosed in Non Patent Literature 1 to 4 just stores documents, and does not carry out any processing as to the analysis of information described in the documents or the entry of the meaning. Thus, users should perform all of the processing related to the information described in the documents, which makes little difference from the visual check by users in terms of complexity.

Further, since all of the techniques disclosed in Patent Literature 1 to 3 are intended only to arrange documents or improve the retrieval performance, users should carry out all of the processing or judgment based on the meaning.

The present invention has been made in view of the foregoing circumstances, and provides a business document processor capable of automatically checking information described in business documents without relying on the visual checks by users.

### Solution to Problem

In order to solve the aforementioned problems, the inventors focused on the facts that the types of vouchers generated within enterprises are limited to certain types, items described in each voucher are fixed, and check item data (e.g., RCM: risk control matrix) prepared by an enterprise for internal control purposes arranges and describes given relationships regarding vouchers generated in the enterprise. In particular, the relationships regarding vouchers that are set forth in the RCM are broadly divided into those (Check Item Examples 1 to 5 described above) related to items described in a single voucher and those (Check Item Examples 6 to 8 described above) related to items described in vouchers that are generated through a series of operations.

That is, a business document processor according to the present invention includes an entered-document analyzing portion that analyzes the structure of an entered business document and generates logical structure data including a plurality of description items, a check item data acquisition portion that acquires check item data for checking the information described in the business document from a database having stored therein the check item data, the check item data corresponding to document type data included in the logical structure data of the entered business document, a description item check-processing portion that checks the information described in the entered business document by comparing the logical structure data of the entered business document with the check item data acquired by the check item data acquisition portion, and a warning display portion that displays a warning when the description item check-processing portion has found a mismatch in the description item of the logical structure data of the entered business document. The check item data herein is RCM (risk control matrix) data including items for checking the information described in the business document or is customer data.

The description item check-processing portion checks if a description item included in the logical structure data of the entered business document satisfies a relationship defined by the check item data.

The check item data acquisition portion, when the check item data includes document type data of a document of a different kind that is related to the entered business document, acquires from a logical structure database logical structure data corresponding to the document of the different kind. Then, the description item check-processing portion checks if a description item included in the logical structure data of the entered business document and a description item included in the logical structure data of the document of the different kind satisfy a relationship defined by the check item data.

The business document processor further includes a data-modification reflecting portion that accepts modification of the mismatched description included in the displayed warning or entry of additional information including a reason why the mismatched description has occurred, and reflects the modification or the additional information into the logical structure data of the entered business document, and a data registration portion that registers in the logical structure database the logical structure data with the reflected modification or additional information.

Further features of the present invention will become apparent from the following best modes for carrying out the invention and the accompanying drawings.

### Advantageous Effects of Invention

According to the business document processor of the present invention, it is possible to automatically check information described in business documents without relying on the visual checks by users.

### BRIEF DESCRIPTION OF DRAWINGS

FIG. 1 is a functional block diagram illustrating the schematic configuration of a business document processor in accordance with an embodiment of the present invention.

FIGS. 2A and 2B illustrate exemplary data structures of RCM data.

FIG. 3 illustrates an exemplary data structure of customer data.

FIG. 4 illustrates an exemplary data structure of the logical structure data of a voucher.

FIG. 5 is a flowchart illustrating the overall processing of a business document processor.

FIG. 6 illustrates an exemplary check display screen.

FIG. 7 is a flowchart illustrating the details of the processing of checking if items described in a voucher satisfy a predetermined relationship.

FIG. 8 illustrates an exemplary warning display screen presented when items described in a voucher do not satisfy a predetermined relationship.

FIG. 9 is a flowchart illustrating the details of the processing of checking if items described in vouchers, which are generated through a series of operations, satisfy a predetermined relationship.

FIG. 10 illustrates an exemplary warning display screen presented when items described in vouchers, which are generated through a series of operations, do not satisfy a predetermined relationship.

FIG. 11A illustrates another exemplary RCM data and FIG. 11B illustrates another exemplary logical structure data of a voucher.

### DESCRIPTION OF EMBODIMENTS

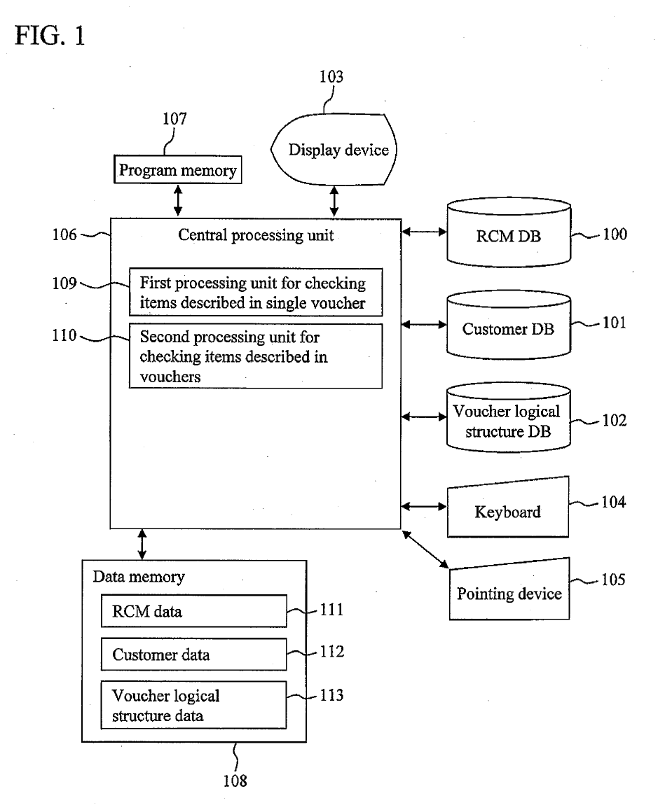

Hereinafter, best modes for implementing a business document processor of the present invention will be described in detail with reference to the accompanying drawings. FIGS. 1 to 11B exemplarily illustrate embodiments of the present invention. It should be noted that portions that are assigned the same reference numerals are the same elements. Thus, the basic structures and operations thereof are assumed to be the same.

<Configuration of Business Document Processor>

FIG. 1 is a functional block diagram schematically illustrating the internal configuration of a business document processor in accordance with an embodiment of the present invention. This business document processor includes an RCM_DB 100 in which RCM (risk control matrix) for a variety of documents is stored, a customer DB 101 in which customer data is stored, a voucher logical structure DB 102 in which the logical structures of vouchers are stored, a display device 103 for displaying data, a keyboard 104 for performing control such as selecting a menu for the displayed data, a pointing device 105 such as a mouse, a central processing unit 106 for executing necessary arithmetic processing, control processing, and the like, program memory 107 in which programs necessary for the processing with the central processing unit 106 are stored, and data memory 108 in which data necessary for the processing with the central processing unit 106 is stored.

The central processing unit 106 includes a first processing unit 109 for checking items described in a single voucher (hereinafter simply referred to as a “first processing unit 109”) that checks if items described in a voucher satisfy a predetermined relationship, displays a warning to a user, and accepts modification and entry of additional information, and a second processing unit 110 for checking items described in vouchers (hereinafter simply referred to as a “second processing unit 110”) that checks if items described in vouchers, which are generated through a series of operations, satisfy a predetermined relationship, displays a warning to a user, and accepts modification and entry of additional information.

The data memory 108 includes RCM data (storage unit) 111 for storing the RCM data that has been acquired from the RCM_DB 100 and is to be used for a read-in voucher document, customer data (storage unit) 112 for storing the target customer data acquired from the customer DB 101, and voucher logical structure data (storage unit) 113 for storing the voucher logical structure data acquired from the voucher logical structure DB 102.

<Structure of Each Data>

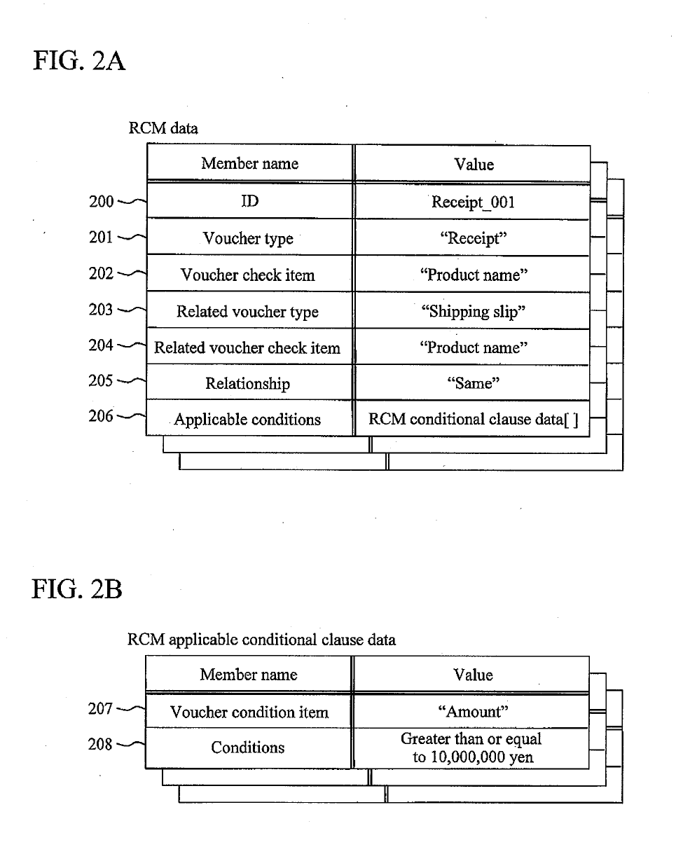

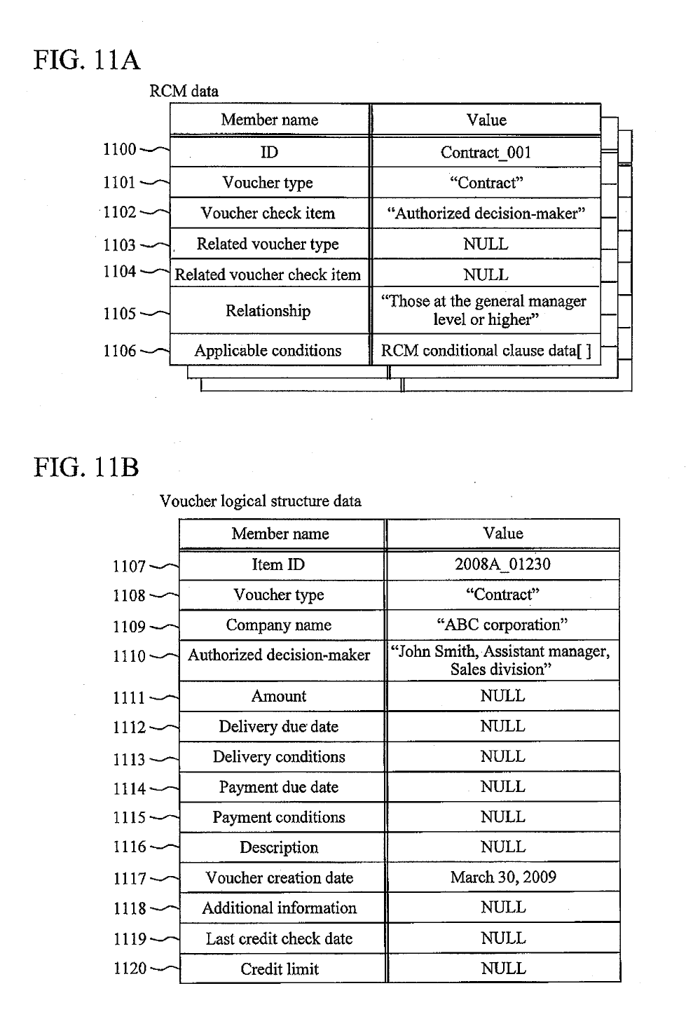

FIGS. 2A to 4 illustrate (exemplary) data structures of the RCM data 111, the customer data 112, and the voucher logical structure data 113 included in the data memory 108. FIGS. 11A and 11B illustrate exemplary RCM data and logical structure data, respectively, of another voucher.

The RCM data illustrated in FIG. 2A includes a voucher ID 200, voucher type 201, voucher check item 202, related voucher type 203, related voucher check item 204, relationship 205, and applicable conditions 206. The applicable conditions are stored in an array of RCM applicable conditional clause data indicated by 207 and 208. The RCM data exemplarily illustrated in FIGS. 2A and 2B is used for checking the relationship between a receipt and a shipping slip. That is, if a “receipt” satisfies the applicable conditions, it means that the “product name” described in the “receipt” and the “product name” described in the “shipping slip” that belongs to the same item as the “receipt” are the “same.” When a single voucher is to be checked, the related voucher type 203 is set to NULL.

The RCM applicable conditional clause data illustrated in FIG. 2B includes a voucher condition item 207 and conditions 208. FIG. 2B illustrates an exemplary condition in which the “amount” should be “greater than or equal to 10,000,000 yen.” Depending on the condition of the amount, it is determined if the decision-maker is the authorized decision-maker, for example, as described later.

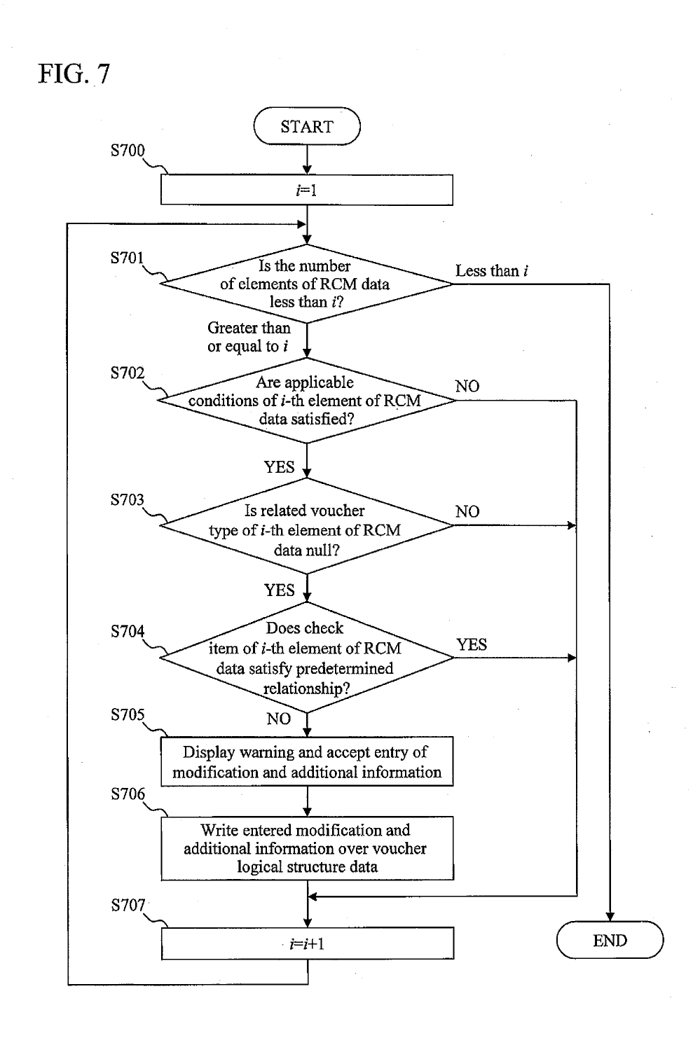

In the example illustrated in FIG. 11A, a related voucher type 1103 indicates NULL. Thus, this is an example of RCM data when check processing is performed only for a single voucher as described later (see FIG. 7). FIG. 11A represents the relationship such that if a “contract” satisfies the applicable conditions, the “authorized decision-maker” described herein is “those at the general manager level or higher.”

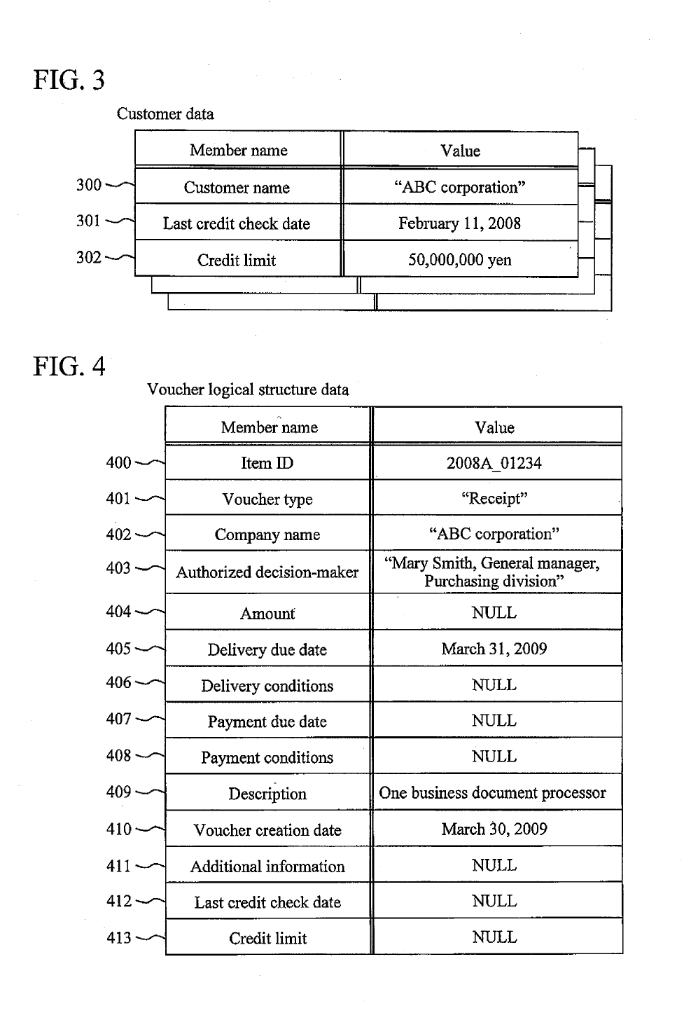

The customer data illustrated in FIG. 3 includes a customer name 300, the last credit check date 301, and credit limit 302. FIG. 3 illustrates an example in which the credit limit for a customer called “ABC Corporation” is “50,000,000 yen” and the credit limit was last checked on “Feb. 11, 2008.”

The voucher logical structure data illustrated in FIG. 4 includes an item ID 400 assigned when a voucher is read in, voucher type 401, company name 402, authorized decision-maker 403, amount 404, delivery due date 405, delivery conditions 406, payment due date 407, payment conditions 408, description 409, voucher creation date 410, additional information 411, the last credit check date 412, and credit limit 413. Information in the fields 400 to 410 indicate the values that are set when a voucher is read in, and information in the fields 411 to 413 indicate the values that are set in the subsequent processing. Information in the fields 402 and 408 can be either present or absent depending on the kind of vouchers. The example of FIG. 4 represents information on a voucher for which the item ID is “2008A_{—}01234” and the voucher type is “receipt,” wherein the company name is “ABC Corporation,” the authorized decision-maker is “Mary Smith, general manager, purchasing division,” the delivery due date is “Mar. 31, 2009,” the description is “one business document processor,” and the voucher creation date is “Mar. 30, 2009.”

The example of FIG. 11B represents information on a voucher for which the item ID is “2008A_{—}01230” and the voucher type is “contract,” wherein the company name is “ABC Corporation,” the authorized decision-maker is “John Smith, assistant manager, sales division,” and the voucher creation date is “Mar. 30, 2009.”

<Specific Processing>

(1) Overall Processing

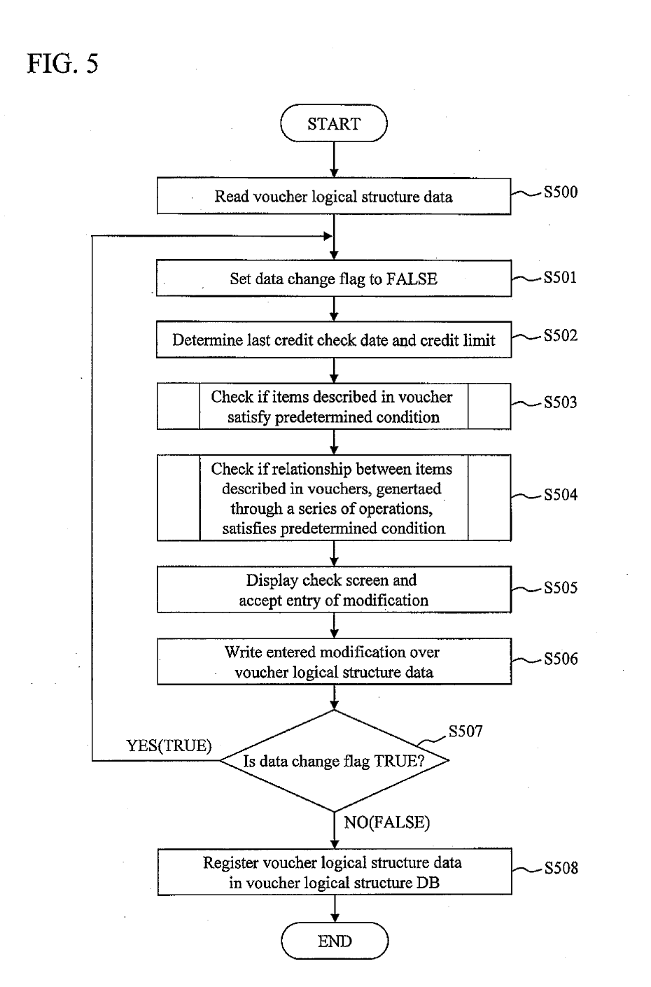

Processing performed by a business document processor in accordance with present embodiment with the aforementioned configuration will now be described. FIG. 5 is a flowchart schematically illustrating the overall processing flow of the business document processor.

In FIG. 5, the central processing unit (CPU) 106 first acquires the logical structure data of a voucher entered via a scanner or the like (not shown), and stores it as the voucher logical structure data 113 (step S500). It should be noted that the techniques of analyzing the logical structures of documents disclosed in Patent Literature 1 to 3 are available as the methods of obtaining the logical structure data of a voucher from a scanned image thereof. Among the values 400 to 410 of the voucher logical structure data 113, those that are not described in the voucher are stored as NULL. At this time, RCM data (see FIG. 2) to be used for check processing is acquired from the RCM_DB 100 based on the voucher type 401 obtained as a result of analyzing of the logical structure of the entered document, and is then stored in the RCM data storage unit 111. There are provided a plurality of pieces of RCM data. One piece of RCM data is referred to as one element. Thus, when there are three pieces of RCM data, the number of elements is three.

Next, the central processing unit 106 sets the data change flag to FALSE (step S501). This flag is sort of an initial value. For the entered voucher logical structure data, the flag is first set to FALSE. Then, the central processing unit 106, with reference to FIG. 3, acquires information about the last credit check date and the credit limit based on the information on the company name (step S502). That is, the central processing unit 106 searches the elements of the customer data 112 stored in the customer DB 101 for a customer name 300 that is the same as the company name 402 of the voucher logical structure data 113. Then, the central processing unit 106 transfers the last credit check date 301 in such an element to the field of the last credit check date 412 of the voucher logical structure data 113, and also transfers the credit limit 302 to the field of the credit limit 413 of the voucher logical structure data 113.

Thereafter, the first processing unit 109 checks if items described in the voucher satisfy a predetermined relationship with reference to the entered voucher data (step S503). In this processing, the first processing unit 109 checks on Exemplary Check Items 1 to 5 described above, for example. Details will be described with reference to FIG. 7.

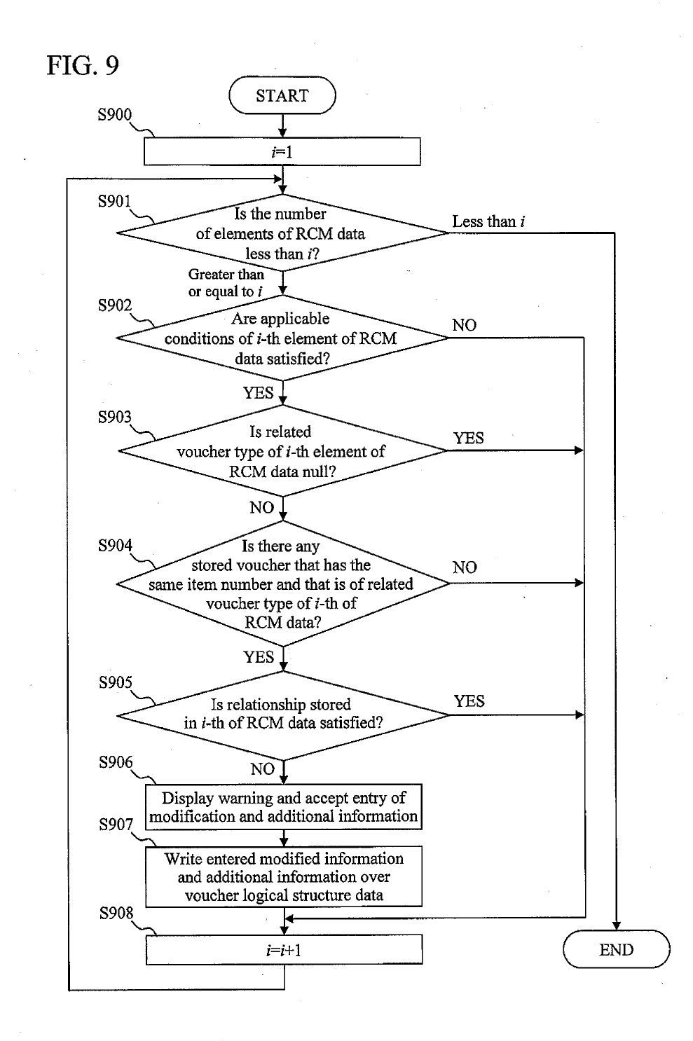

The second processing unit 110 checks if items described in vouchers, which are generated through a series of operations, satisfy a predetermined relationship (step S504). This is the processing of checking for the presence of match conditions between a voucher that has already been generated and the entered voucher. The second processing unit 110 checks on Exemplary Check Items 6 to 8 described above, for example. Details will be described with reference to FIG. 9.

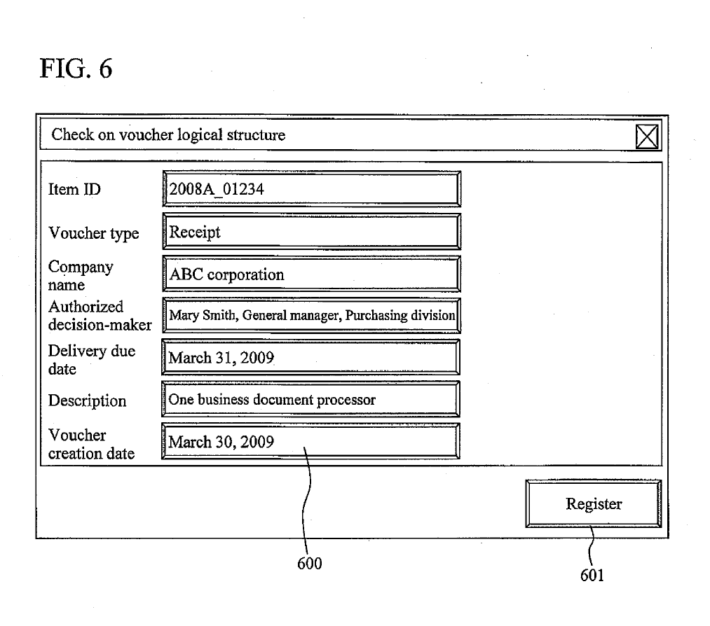

Then, the central processing unit 106 displays on the display device 103 a check screen of the voucher logical structure data, and accepts entry of modification from users (step S505). The screen displayed herein is like the one illustrated in FIG. 6. The content of the logical structure data is displayed as indicated by 600 in FIG. 6. The user can click on a button 601 for registering values after modifying them, or can click on the button 601 for registering values without modifying them. If any modification has occurred, the flag changes to TRUE upon modification.

When the user has clicked on the bottom 601 after modifying the values, the central processing unit 106 reflects such changes into the voucher logical structure data 113, and sets the data change flag to TRUE (step S506). Further, the central processing unit 106 checks if the data change flag is TRUE (step S507), and if the answer to step S507 is YES, the flow returns to step S501 to restart the processing. This is for rechecking purposes because a flag indicating TRUE means that some modification has occurred.

If the answer to step S507 is NO, the central processing unit 106 stores the content, which is stored as the voucher logical structure data 113, into the voucher logical structure DB 102 (step S508), and terminates the processing.

(2) Check Processing for Items Described in a Single Voucher

FIG. 7 is a flowchart illustrating the details of step S503 in FIG. 5, that is, the processing of checking if items described in a voucher satisfy a predetermined relationship. In FIG. 7, the subject that performs the processing of each step is the first processing unit 109 unless otherwise specified.

First, the first processing unit 109 initializes the index variable i with 1 (step S700). Next, the first processing unit 109 checks if the number of elements of the RCM data 111 stored in the RCM_DB 100 is less than i, and if it is determined to be less than i, the processing terminates (step S701). If the number of elements is determined to be greater than or equal to i, the flow further proceeds to step S702, whereas if the number of elements is determined to less than i, (less than 1 initially), the processing terminates. This is because there are no more RCM elements to be checked.

Then, the first processing unit 109 checks if the applicable conditions 206 (conditional clause data) of the i-th element of the RCM data 111 are satisfied (step S702). If the answer to step S702 is NO, the flow proceeds to step S707, and if YES, the flow proceeds to step S703. That is, the first processing unit 109 checks if the related voucher type 203 of the i-th element of the RCM data 111 indicates NULL (step S703). If the answer to step S703 is NO, it means that the element describes the relationship between vouchers. Thus, since such a voucher is not the check subject here, the flow proceeds to step S707.

If the answer to step S703 is YES, the flow proceeds to step S704. Then, the first processing unit 109 checks if the voucher check item 202 of the i-th element of the RCM data 111 satisfies the relationship stored in the field of the relationship 205 (S704). If the answer to step S704 is NO, the flow proceeds to step S705, and if YES, the flow proceeds to step S707.

In step S705, the central processing unit 106 displays a warning on the display device 103 and accepts entry of modification and additional information from users (step S705).

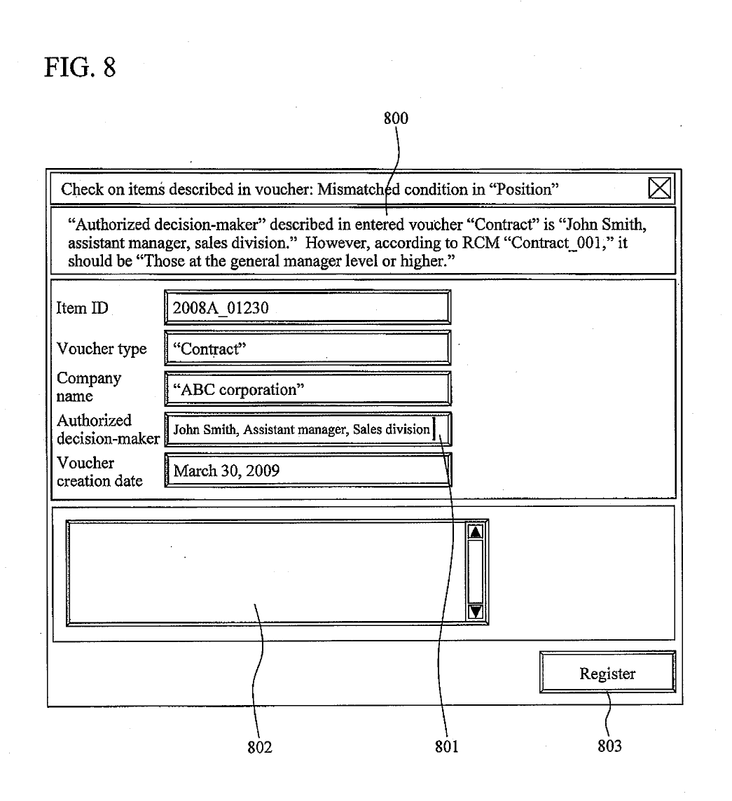

The warning display screen displayed in step S705 is like the one illustrated in FIG. 8, for example. As indicated by 800 in FIG. 8, the central processing unit 106 displays on the display device 103 information to the effect that the relationship described in the i-th element of the RCM data 111 is not satisfied, with embedded therein the following information: the ID 1100 (“contract_{—}011” in the example of FIG. 8), the voucher type 1101 (“contract” in the example of FIG. 8), the voucher check item 1102 (“authorized decision-maker” in the example of FIG. 8), the relationship 1105 (“those at the general manager level or higher” in the example of FIG. 8), and the value of the corresponding item in the voucher logical structure data 113 (“John Smith, assistant manager, sales division” in the example of FIG. 8). In the example of FIG. 8, the related voucher type 1103 indicates NULL based on the premise that the i-th element of the RCM data 111 does not specify any voucher that “should be checked in relation to the contract (the voucher type 1101).” The voucher check item 1102 herein is the “authorized decision-maker.” The warning display 800 is displayed here because the authorized decision-maker indicated in FIG. 8 is the “assistant manager” although it should be “those at the general manager level or higher.”

The central processing unit 106 displays the contents of the logical structure data 1107 to 1117 and 1118 to 1120 as indicated by 801, and also displays an area for entering additional information as indicated by 802. Users can click on a button 803 in registering values after modifying the information in the area 801 or entering information into the area 802, or can click on the button 803 in registering values without modifying or entering any information.

FIG. 8 exemplarily illustrates a case in which a user is modifying the information in the area 801 with a prompt displayed in the field of the authorized decision-maker. Accordingly, modification is possible even if errors occur in the process of acquiring the logical structure data of a voucher from a scanned image thereof, as described in the techniques of analyzing the logical structures of documents in Patent Literature 1 to 3.

When a user has clicked on the button 803 after modifying and entering information, the modified information and newly entered information are reflected into the voucher logical structure data 113, and also the data change flag is set to TRUE (step S706). Here, when a user has entered information into the area 802, such information is stored as the additional information 1118.

Thereafter, the index variable i is increased by one (step S707) and then the flow returns back to step S701 to restart the processing.

(3) Check Processing for Items Described in Vouchers

FIG. 9 is a flowchart illustrating the details of step S504 in FIG. 5, that is, the processing of checking if items described in vouchers, which are generated through a series of operations, satisfy a predetermined relationship. In FIG. 9, the subject that performs the processing of each step is the second processing unit 110 unless otherwise specified.

First, the second processing unit 110 initializes the index variable i with 1 (step S900). Next, the second processing unit 110 checks if the number of elements of the RCM data 111 stored in the RCM_DB 100 is less than i, and if it is determined to be less than i, the processing terminates (step S901). If the number of elements is determined to be greater than or equal to i, the flow further proceeds to step S902, whereas if the number of elements is determined to be less than i, (less than 1 initially), the processing terminates. This is because there are no more RCM elements to be checked.

Then, the second processing unit 110 checks if the applicable conditions 206 of the i-th element of the RCM data 111 are satisfied (step S902). If the answer to 5902 is NO, the flow proceeds to step S908.

If the answer to 5902 is YES, the second processing unit 110 checks if the related voucher type 203 of the i-th element of the RCM data 111 indicates NULL (step S903). If the answer to step S903 is YES, it means that the element describes the relationship regarding a single voucher. Thus, since such a voucher is not the check subject here, the flow proceeds to step S908.

If the answer to step S903 is NO, the second processing unit 110 checks if the voucher logical structure DB 102 has stored therein a voucher that has the same item ID as the item ID 400 of the voucher logical structure data 113 and has the same voucher type as the related voucher type 203 of the i-th element of the RCM data 111 (step S904). If such a voucher is not stored, the flow proceeds to step S908.

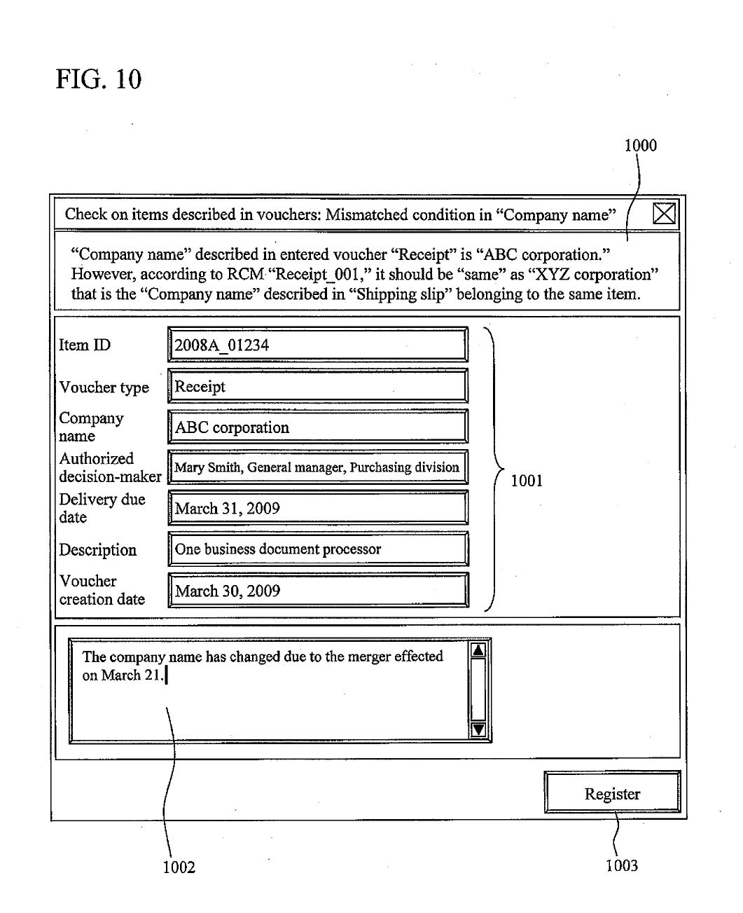

If the relevant voucher is stored in the voucher logical structure DB 102, the second processing unit 110 checks if the relationship 205 stored in the i-th element of the RCM data 111 is satisfied (step S905). If the answer to step S905 is NO, the central processing unit 106 first displays a warning and then accepts entry of modification and additional information from users (step S906). A warning screen displayed herein is like the one illustrated in FIG. 10. As indicated by 1000, description to the effect that the relationship described in the i-th element of the RCM data is not satisfied is displayed. The warning text template as indicated by 1000 includes blanks “.” With the blanks filled in with relevant items, warning text to alert a condition mismatch is generated. For example, the blanks “ ” displayed in the warning text template are filled in with the ID 200 (“receipt_{—}001” in the example of FIG. 10), the voucher type 201 (“receipt” in the example of FIG. 10), the voucher check item 202 (“company name” in the example of FIG. 10), the related voucher type 203 (“shipping slip” in the example of FIG. 10), the related voucher check item 204 (“company name” in the example of FIG. 10), the relationship 205 (“same” in the example of FIG. 10), the value of the corresponding item in the voucher logical structure data 113 (“ABC Corporation” in the example of FIG. 10), and the value of the corresponding item in the voucher logical structure data stored in the voucher logical structure DB 102 (“XYZ Corporation” in the example of FIG. 10).

In addition, the contents of the logical structure data are displayed as indicated by 1001, and an area for entering additional information is also displayed as indicated by 1002. Users can click on a button 1003 for registering values after modifying the information in the area 1001 and entering information into the area 1002, or can click on the button 1003 for registering values without modifying or entering any information. FIG. 10 illustrates an example in which a user is entering information into the area 1002 for entry of additional information. Accordingly, it is possible to explicitly show, in registration of a voucher, the reason for the irregular handling of the voucher, and promptly explain such reason to auditors in audit, thereby reducing the number of steps.

When a user has clicked on the button 1003 after modifying and entering information, the modified information and newly entered information are reflected into the voucher logical structure data 113, and also the data change flag is set to TRUE (step S907). Here, when a user has entered information into the area 1002, such information is stored as the additional information 411.

Thereafter, the index variable i is increased by one (step S908) and then the flow returns back to step S901 to restart the processing.

### CONCLUSION

According to the present embodiment, the content of a voucher is automatically checked in registration of the voucher, whereupon a warning is displayed for a user and entry of additional information is accepted. Thus, it is possible to prevent flaws in the description of the voucher and surely collect information about the reasons for the irregular handling of the voucher. In particular, it is possible to surely perform check by checking if items described in a voucher satisfy a predetermined condition or by checking if items described in vouchers, which are generated through a series of operations, satisfy a predetermined relationship. It should be noted that vouchers that are generated through a series of operations are identified based on the information on a related voucher included in the check item data (e.g., RCM data) acquired for a given voucher to be checked.

By checking the content of a voucher using RCM, it is possible to check the content of the voucher in accordance with the business content of each enterprise. RCM is a document that is normally created in enterprises for internal control purposes. Using RCM can reduce the number of steps required for constructing and operating systems. Similar effects can also be expected when the content of a voucher is checked using information that has been processed based on the RCM.

Further, by checking the content of a voucher using customer data, it is possible to check the content of the voucher in accordance with each transaction item.

It should be noted that the present invention can also be realized by a program code of software that implements the function of the embodiment. In such a case, a storage medium having recorded thereon the program code is provided to a system or an apparatus, and a computer (or a CPU or MPU) in the system or the apparatus reads the program code stored in the storage medium. In this case, the program code itself read from the storage medium implements the function of the aforementioned embodiment, and the program code itself and the storage medium having recorded thereon the program code constitute the present invention. As the storage medium for supplying such a program code, for example, a flexible disk, CD-ROM, DVD-ROM, a hard disk, an optical disc, a magneto-optical disc, a CD-R, a magnetic tape, a nonvolatile memory card, ROM, or the like is used.

Further, based on an instruction of the program code, an OS (operating system) running on the computer or the like may perform some or all of actual processes, and the function of the aforementioned embodiment may be implemented by those processes. Furthermore, after the program code read from the storage medium is written to the memory in the computer, the CPU or the like of the computer may, based on the instruction of the program code, perform some or all of the actual processes, and the function of the aforementioned embodiment may be implemented by those processes.

Moreover, the program code of the software that implements the function of the embodiment may be distributed via a network, and thereby stored in storage means such as the hard disk or the memory in the system or the apparatus, or the storage medium such as a CD-RW or a CD-R, and at the point of use, the computer (or the CPU or the MPU) in the system or the apparatus may read the program code stored in the storage means or the storage medium and execute the program code.

### REFERENCE SIGNS LIST

100: RCM DB
101: customer DB
102: voucher logical structure DB
103: display device
104: keyboard
105: pointing device
106: central processing unit
107: program memory
108: data memory

1. A business document processor that performs check processing for information described in a business document and registers the business document in a database, comprising:
an input portion configured to enter the business document;
an entered-document analyzing portion configured to analyze the structure of the entered business document and generate logical structure data including a plurality of description items;
a check item data acquisition portion configured to acquire check item data for checking the information described in the business document from a database having stored therein the check item data, the check item data corresponding to document type data included in the logical structure data of the entered business document;
a description item check-processing portion configured to check the information described in the entered business document by comparing the logical structure data of the entered business document with the check item data acquired by the check item data acquisition portion; and
a warning display portion configured to display a warning when the description item check-processing portion has found a mismatch in the description item of the logical structure data of the entered business document.

2. The business document processor according to claim 1,
wherein:
the check item data is RCM (risk control matrix) data including items for checking the information described in the business document, the check item data acquisition portion acquires from an RCM database the RCM data corresponding to the document type data included in the logical structure data of the entered business document, and
the description item check-processing portion checks the information described in the entered business document by comparing the logical structure data of the entered business document with the RCM data acquired by the check item data acquisition portion.

3. The business document processor according to claim 1,
wherein:
the check item data is customer data included in the business document,
the check item data acquisition portion acquires from a customer database the customer data corresponding to the document type data included in the logical structure data of the entered business document, and
the description item check-processing portion checks the information described in the entered business document by comparing the logical structure data of the entered business document with the customer data acquired by the check item data acquisition portion.

4. The business document processor according to claim 1, wherein the description item check-processing portion checks if a description item included in the logical structure data of the entered business document satisfies a relationship defined by the check item data.

5. The business document processor according to claim 1,
wherein:
the check item data acquisition portion, when the check item data includes document type data of a document of a different kind that is related to the entered business document, acquires from a logical structure database logical structure data corresponding to the document of the different kind, and
the description item check-processing portion checks if a description item included in the logical structure data of the entered business document and a description item included in the logical structure data of the document of the different kind satisfy a relationship defined by the check item data.

6. The business document processor according to claim 1, further comprising:
a data-modification reflecting portion configured to accept modification of the mismatched description included in the displayed warning or entry of additional information including a reason why the mismatched description has occurred, and reflect the modification or the additional information into the logical structure data of the entered business document; and
a data registration portion configured to register in the logical structure database the logical structure data with the reflected modification or additional information.
